(19) United States
(12) Patent Application Publication
(10) Pub. No.: US 2022/0297079 A1
(43) Pub. Date: Sep. 22, 2022

(54) REACTION APPARATUS

(71) Applicant: THE UNIVERSITY OF NOTTINGHAM, Nottingham, Nottinghamshire (GB)

(72) Inventors: Michael George, Nottingham, Nottinghamshire (GB); Martyn Poliakoff, Nottingham, Nottinghamshire (GB); Darren Lee, Nottingham, Nottinghamshire (GB); Stephen Pickering, Nottingham, Nottinghamshire (GB); Medhat Sharabi, Nottingham, Nottinghamshire (GB)

(21) Appl. No.: 17/635,480

(22) PCT Filed: Aug. 14, 2020
(86) PCT No.: PCT/GB2020/051946

§ 371 Date: Feb. 15, 2022

(30) Foreign Application Priority Data
Aug. 16, 2019 (GB) 1911815.7

(51) Int. Cl. B01J 19/18; B01J 19/12

(52) U.S. Cl. CPC B01J 19/1818; B01J 19/127; B01J 19/128; B01J 19/123; B01J 19/1806; B01J 19/1843; B01J 2219/0059; B01J 2219/00711; B01J 2219/00713; B01J 2219/0839; B01J 2219/00085

(57) ABSTRACT

An apparatus for carrying out chemical reactions is provided. The apparatus comprises a first reactor/reaction zone for carrying out a first chemical reaction and a second reactor/reaction zone for carrying out a second chemical reaction. Each reactor/reaction zone comprises: a) an inner surface and an outer surface which are spaced apart from each other to define a reaction volume configured such that, in use, a respective chemical reaction takes place in the reaction volume, and wherein the inner surface and outer surface are configured for relative rotation with respect to each other, (b) an inlet for introduction of a reagent to the reaction volume, and (b) an outlet through which a reaction product can leave the reaction volume. The reaction products of the first reactor/reaction zone comprise reagents of the second reactor/reaction zone.

### FIELD

The present disclosure relates to an apparatus and reactor for carrying out chemical reactions, more particularly but not exclusively for carrying out photochemical reactions, electrochemical reactions and/or thermal reactions.

### BACKGROUND

Continuous flow chemistry is an increasingly popular alternative to traditional batch operations in both academic and industrial settings. As new developments are made in synthetic methodology, fine chemical synthesis and active pharmaceutical ingredient (API) synthesis, there is parallel interest in translating these methodologies to continuous processes.

Continuous flow chemistry can provide safer, more efficient, and automated operations. Reactions where scalability in batch is problematic have often benefitted from being applied to continuous reactors.

Further, with the growing interest of tailored medicine for individual patients, there is a growing need for reaction apparatus designed to produce smaller volumes of targeted pharmaceuticals for more focused treatment. Therefore smaller volume production is also of interest. Moreover a shift in chemical processing away from large bespoke chemical plants to highly globally dispersed, just-in-time manufacture of smaller quantities requires highly adaptive, efficient and economical chemical manufacturing processes producing smaller volumes.

The present teachings seek to overcome or at least mitigate one or more problems associated with the prior art.

### SUMMARY

In an aspect of the disclosure, a reactor for carrying out chemical reactions is provided, the reactor comprising:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which a reaction product can leave the reaction chamber.

In exemplary embodiments, the chemical reaction may comprise a biocatalytic reaction.

When in use, reagent(s) are introduced to the reaction chamber via the inlet, the reaction fluid flows through the reaction chamber, and reaction product(s) leave the reaction chamber via the outlet. Due to the relative rotation of the inner and outer surfaces, so-called “Taylor vortices” or “Taylor-Couette vortices” are generated in the reaction fluid flowing through the reaction chamber. These are toroidal vortices generated in the reaction chamber. Fluid flow in the region of the vortices create turbulent flow in the reaction fluid and so aid mixing of reagents in the reaction chamber.

In exemplary embodiments, where the reagents include gas and liquid phases, mixing achieved by the vortices enables rapid mass transfer between the gas and the liquid phases, allowing for a high efficiency dissolution of gases.

Where flammable reagents or products are present, the flow chemistry approach allows continuous flow of reagent solution, which can be effectively mixed and reaction products quickly removed from the reactor. This reduces the potential for flammable mixture build-up.

Reactions with molecular oxygen (O₂) are highly desirable as they are highly atom economical and environmentally benign, and O₂ is readily available and abundant in the atmosphere. However, scale-up of such reactions can present issues. Molecular oxygen is often used as an oxidant or as a reagent, where it can be incorporated into molecules, in particular using photochemistry, wherein singlet oxygen (¹O₂) is generated and reacted with electron-rich functional groups. Such reactions are often not carried out on a large scale because the use of pure oxygen poses several risks. For example, when flammable solvents are used, the problem of potential ignition or explosion of the solvent is always present.

Reactors disclosed herein enable a large liquid phase and relatively small gas phase volume to be used (for example, a gas phase of less than 2% by volume). The mixing of reagents achievable via generation of Taylor vortices results in very small gas bubbles being produced. In this way, for reactions with molecular oxygen, a lower volumetric concentration of gaseous oxygen can be used, e.g. below the limiting oxygen concentration, which is a region in which combustion is less likely.

The degree of mixing is determined by the movement of the Taylor vortices in the reaction fluid, and not the flow rate through the reactor. In this way, the properties of “flow rate” and “extent of mixing” are decoupled from one another. Consequently, the extent of mixing can be tailored for a particular reaction independently of flow rate, and vice versa. This results in a more versatile reaction apparatus. As will be described in further detail below, this is also advantageous where two or more reactors are coupled together in series, since the same flow rate can be maintained, whilst the reaction conditions and thus the extent of mixing in each reactor can be adjusted as desired.

The nature of the Taylor vortices, and hence the extent of mixing, is dependent upon the speed of relative rotation of the inner and outer surfaces. The nature of the Taylor vortices, and hence the extent of mixing, may also be dependent on the dimensions of the reactor and/or the properties of the reaction fluid.

In exemplary embodiments, the inner and/or outer surfaces are at least partially textured.

In exemplary embodiments, the inner and/or outer surfaces are at least partially smooth.

The inner and outer surfaces of the reactor may define a reaction chamber having annular cross section.

In some embodiments, the inner and/or outer surfaces are approximately cylindrical. The inner and outer surfaces may comprise concentric approximately cylindrical surfaces. In such embodiments, the Taylor vortices generated are toroidal vortices threaded around the inner approximately cylindrical surface.

For example, the cylindrical surface(s) may have a circular or elliptic cross section. In some embodiments, the cylindrical surface(s) may have a cross section that is distorted away from a true circle or ellipse. In some embodiments, the inner and/or outer surfaces comprise a distorted cylinder.

In some embodiments the inner and/or outer surfaces comprise an ellipsoid shape.

The reactor may comprise a flow path configured such that fluid can flow along the flow path from the input to the output via the reaction chamber. In this way, the reactor is configured for flow chemistry applications.

The reactor may comprise, be coupled to or be configured to be coupled to a pump configured to generate a continuous flow of fluid along the flow path.

The inner surface and the outer surface may be spaced apart by a predetermined distance, e.g. gap size.

Optionally, a gap size between the inner and outer surfaces and/or the speed of relative rotation between the surfaces of the reactor is configured or configurable such that, in use, Taylor vortices are generated in fluid present in the reaction chamber.

Optionally, the reactor comprises a rotor defining the inner surface of the reaction chamber, wherein the rotor is configured to rotate such that the inner surface rotates with respect to the outer surface of the reaction chamber.

In some embodiments, the outer surface does not rotate. In some embodiments the outer surface is configured to rotate. In some embodiments, both the inner and outer surfaces are configured to rotate.

In exemplary embodiments, the rotor comprises a metallic material and/or a plastics material, e.g. PEEK. The rotor may be solid or hollow.

In exemplary embodiments, the rotor may be impregnated with, or be constructed from, a material or materials desirable for a given chemical reaction, for example, a material or materials which act as a catalyst or reagent (e.g. a precious metal) in a reaction.

In exemplary embodiments, the rotor may be covered with a jacket, for example a removable jacket. The jacket may be impregnated with, or be constructed from, a material or materials desirable for a given chemical reaction, for example, a material or materials which act as a catalyst or reagent (e.g. a precious metal) in a reaction.

In the case where the jacket is removable, this provides a more flexible reactor which is readily adaptable to a variety of syntheses, which is beneficial for industrial applications of the reactor.

The reactor may comprise a reaction vessel defining the outer surface of the reaction chamber. The rotor may be located, at least partially, in the reaction vessel. In some embodiments, the reaction vessel does not rotate. Rather the relative rotation is caused by rotation of the rotor. In some embodiments the reaction vessel is configured to rotate. In some embodiments, both the rotor and the reaction vessel are configured to rotate.

The reaction vessel may comprise a jacketed vessel through which heating or cooling fluid can be circulated for controlling the temperature of fluid flowing through the reactor. In this way, overheating of the reaction vessel can be reduced or avoided.

Additionally or alternatively, in this way, the temperature of the reaction vessel can be optimised, for example, for thermal reactions.

The jacketed vessel may be a double-walled reaction vessel. Coolant or heating fluid may be passed between the double walls to control the temperature of the reaction vessel.

The reactor may be configured for relative rotation of the inner and outer surfaces of in the range of 1-10,000 rpm, for example 20-7500 rpm, for example 50-5000 rpm, for example 100-5000 rpm, for example 500-4000 rpm, for example e.g. 1000-4000 rpm. When in use, the generation of Taylor vortices in the reaction fluid, and the properties of the Taylor vortices generated, will depend, at least in part, on the relative rotation speed. Accordingly, by controlling the relative rotation speed, the extent of mixing can also be controlled in combination with variation of the gap size

The reactor may comprise a longitudinal axis, wherein the inner and outer surfaces are configured for relative rotation about the longitudinal axis. In exemplary embodiments, the longitudinal axis is substantially vertical. Alternatively, the longitudinal axis may be substantially horizontal.

In exemplary embodiments, the reaction vessel is configured to be stackable such that a plurality of reaction vessels can be stacked one on top of another. For example, the reaction vessel may comprise one or more flanges to facilitate stacking. This enables a longer reactor length to be achieved as and when required, hence increasing the flexibility of the system. Stacking reaction vessels also continues to enable the surface area to volume ratio of the outer surface to the reaction vessel volume remains constant.

Consequently, the same amount of light per unit volume of the vessel can be achieved, even when the reactor is scaled up.

In some embodiments, the reaction vessel comprises a single vessel, for example having multiple reaction zones. This is of particular use in reaction systems where flow rates need not be decoupled.

In exemplary embodiments, the reaction vessel may be open topped and/or open bottomed, for example to facilitate stacking.

In exemplary embodiments, the reaction chamber has an outer internal radius of in the range 5 to 50 mm, e.g. 10, 15, 20, 25, 30, 35, 40 or 45 mm or ranges between these values. With the growing interest in tailored medicine for individual patients, there is a need for smaller amounts of targeted pharmaceuticals for focused treatment. Therefore, smaller volume production, hence relatively small reaction vessels, is of interest.

In exemplary embodiments, the reaction chamber has an outer internal radius of in the range 5 cm to 150 cm, e.g. 10, 20, 30, 40, 50, 60, 70, 80, 90, 100, 110, 120, or 130, 140 cm or ranges between these values.

In some embodiments, the reaction vessel is open topped. In this way, air can be drawn into the reaction vessel from the top surface of the reaction liquid. In such embodiments, reaction products can be drawn from the upper surface of the reaction fluid.

In some embodiments, the reaction vessel comprises a closed top which is sealed to prevent ingress of air from the atmosphere. In such embodiments, a gas inlet tube may be provided for providing air or other gases to the reaction chamber. This arrangement permits greater control of the introduction of air or gas to the reaction. For example, in this arrangement, gas can be introduced more slowly, controlling the production of gas bubbles in the reaction fluid. This also enables control of the free gas volume in the reaction fluid, which enhances the safety of the system. Additionally, the use of a closed/sealed top allows pure oxygen to be used safely, instead of air. This increases the concentration of oxygen available, e.g. by 5 times. Alternatively, other gases required by the reaction can be used.

In exemplary embodiments, the reaction vessel may be sealed to prevent ingress of air from the atmosphere.

In exemplary embodiments, the inlet comprises a bore through the rotor. Where the rotor is supported at its upper end, the bore is configured to introduce reagents towards the lower end of the reaction chamber. Where the rotor is supported at its lower end, the bore is configured to introduce reagents towards the upper end of the reaction chamber.

In alternative embodiments, the inlet and/or outlet is provided at a perimeter of the reaction chamber, e.g. a bottom, top or side of the reaction chamber.

The chemical reaction carried out by the reactor may be a photochemical reaction, an electrochemical reaction and/or a thermal reaction.

In exemplary embodiments, reactors disclosed herein may be for carrying out reactions which require electromagnetic radiation to be transmitted to the reagents in the reaction chambers.

In some embodiments, the inner and/or outer surface is formed of a material which permits electromagnetic radiation of a desired wavelength to be transmitted to the reaction chamber.

In some embodiments, the reactor, or an apparatus comprising the reactor, further comprises an electromagnetic radiation source.

In an aspect of the disclosure, a reactor for carrying out chemical reactions is provided, the reactor comprising:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which a reaction product can leave the reaction chamber,
wherein the chemical reaction is a photochemical reaction.

Photochemical reactions occur when visible light and/or ultraviolet light and/or infrared radiation is absorbed by molecule(s) and this process introduces energy sufficient to break or reorganise chemical bonds. In this way photochemistry can promote reactions which may not occur by merely heating a reaction mixture, and/or may enable some reactions to proceed in a greener and potentially more energy efficient way.

The advantages of photochemistry have long been recognised, but technical difficulties in designing photoreactors that can operate efficiently have been an obstacle.

Reactors disclosed herein enable improved light penetration in photochemical reactions. The rapid mixing generated by the vortices enables every part of the solution to pass close to the inner and/or outer surface of the reaction chamber, thereby being exposed to the maximum light intensity. In this way, the efficiency and/or yield of a photochemical reaction can be enhanced. Further, since light penetration is enhanced, a smaller reactor length is possible. Additionally or alternatively over-radiation of reagents can be reduced or avoided.

In the case of photochemical reactions, the inner and/or outer surface of the reactor permits visible light and/or ultraviolet light and/or infrared radiation to enter the reaction chamber. In other words, the inner and/or outer surface comprises wholly or in part a transparent or translucent material such that visible light and/or ultraviolet light and/or infrared radiation can enter the reaction chamber.

In some embodiments, the outer and/or inner surface comprises a mesh such that electromagnetic radiation (e.g. visible light and/or ultraviolet light and/or infrared radiation) can enter the reaction chamber via the gaps in the mesh.

In some embodiments, the inner and/or outer surface of the reactor permits visible light and/or ultraviolet light and/or infrared radiation having a desired wavelength to enter the reaction chamber, e.g. corresponding to an optimal wavelength for a given photochemical reaction. Transmitting electromagnetic radiation at this wavelength to the reaction vessel will increase the efficiency and optimise the reaction. In this way, the reactor can be tailored for particular photochemical reactions.

In some embodiments, the reactor or an apparatus comprising a reactor further comprises a visible light and/or ultraviolet light and/or infrared radiation source, e.g. a visible light source. For example, a white light source may be used.

In some embodiments, an electromagnetic radiation source (e.g. a visible light source) is provided which is configured to transmit radiation at a desired wavelength, which is optimal for a given reaction (e.g. photochemical reaction). This will increase the efficiency and optimise the energy required for the reaction.

In exemplary embodiments, an LED light source is used. In this way, a point light source is provided which does not require optics or lenses. Any other suitable radiation source may be used.

In exemplary embodiments, the radiation source is positioned at an exterior of the reaction vessel. In other words, the radiation source is not positioned within the reaction vessel itself. In such embodiments, the radiation source may comprise cooling fins, mechanical fans or other temperature control mechanisms such that excess heat from those sources is removed from the system without passing through the reaction mixture.

In some embodiments, a radiation source is positioned within the rotor and radiation enters the reaction chamber through the inner surface.

In some embodiments, the inner surface comprises a reflective surface, e.g. is metal coated. In this way, electromagnetic radiation, e.g. visible light, can be reflected back into the reaction chamber to increase the amount of radiation transmitted to the reaction chamber. In exemplary embodiments, the rotor may be metal coated.

In some embodiments, the rotor may be entirely metal, comprise a metal sleeve forming the inner surface, and/or be powder coated with a catalyst.

In the case of exemplified photochemical reactions, the gap size between the inner surface and the outer surface the reactor may be up to 50 mm, for example in the range 1 and 50 mm, e.g. 1 to 20 mm, 1 to 10 mm, 1 to 5 mm, e.g. about 3 mm.

The reactor is not limited by photochemical reaction, however some reactions which could be completed using the reactor include: photo initiated free-radical reactions, such as polymerisation; and photoisomerisation, such as of co-ordination complexes.

In an aspect of the disclosure, a reactor for carrying out chemical reactions is provided, the reactor comprising:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which a reaction product can leave the reaction chamber,
wherein the chemical reaction is a thermal reaction.

The improved mixing achievable by reactors disclosed herein enables a more uniform thermal profile through the reaction fluid to be achieved. This is beneficial for thermal reactions.

In some embodiments, the reactor comprises a heat source, e.g. where the chemical reaction promoted by heat.

In some embodiments, the reactor comprises a heat sink, e.g. where the chemical reaction is an exothermic reaction.

In some embodiments, in the case of thermal reactions, the gap size between the inner surface and the outer surface the reactor may be up to 50 mm, for example in the range 1 and 50 mm, e.g. 1 to 20 mm, 1 to 10 mm, 1 to 5 mm, e.g. about 3 mm.

In an aspect of the disclosure, a reactor for carrying out chemical reactions is provided, the reactor comprising:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which of a reaction product can leave the reaction chamber,
wherein the inner and outer surfaces are configured as electrodes and wherein the chemical reaction is an electrochemical reaction.

In some electrochemical reactions, fresh reaction solution is needed at the electrodes in order to improve the performance of the reaction. When reactors described herein are in use, reaction fluid flows through the reaction chamber from the inlet to the outlet. Vortices generated in the reaction chamber mix the reaction fluid as it flows through the reaction chamber. In this way, fresh solution is provided at the electrodes.

Additionally, use of reactors described herein result in relatively small gas bubbles being created, which reduce electrical resistance in the system.

Either the inner surface or the outer surface forms the anode, with the other of the inner or outer surface forming the cathode. The cathode and the anode materials will often be selected such that they are a good voltage match for the other of the cathode or anode. The anode and cathode may be the same, although often they will be different.

The gap size between the inner surface and the outer surface of the reactor is up to 8 mm, for example in the range 0.1-8 mm, for example 0.5-8 mm, for example 1-6 mm. Optionally the gap size is about 0.5 mm. Optionally the gap size is about 1.0 mm. For example, the gap size may be up to 6 mm, e.g. in the range of 1-6 mm, for a rotor of 20 mm diameter.

The reactor may be configured to minimise lateral movement of the inner surface and/or outer surface during relative rotation. In this way, contact between the two electrodes is inhibited.

The reactor may comprise a carbon-containing electrode.

In some embodiments the anode is porous. In many cases the anode will be formed from a carbon containing material such as graphite or graphene, and may be of layered structure with a graphene coating and a metallic, often copper, aluminium or lithium alloy core. Alternatively, the anode may be a metal such as copper, aluminium, lithium, copper, zinc, manganese, cobalt, nickel or combinations thereof. Often the anode may be a lithium alloy such as alloys of lithium with one or more of Li are Al, Bi, Cd, Mg, Sn, and Sb or lithium oxides such as lithium titanium oxide. Alternatively, the anode may comprise a silicon material, such as a silicon-carbon composite. In some embodiments, the anode may comprise steel or other metal alloys.

In some embodiments, the cathode will be porous, often the cathode will be formed from a metal containing material, wherein the metal may be copper, aluminium, lithium, copper, zinc, manganese, cobalt, nickel or combinations thereof. Often the cathode will be selected from LiCoO₂, Li—Mn—O, LiFePO₄ and lithium layered metal oxides such as LiNi_{0.5}Mn_{0.5}O₂ and Li_{1.2}Cr_{0.4}Mn_{0.4}O₂. In some embodiments, the cathode may comprise steel or other metal alloys

In view of the nature of the reactor a liquid electrolyte or reaction mixture containing an electrolyte will be present between the cathode and the anode, although the nature of the electrolyte is not limited beyond the need to be capable of transporting electric charge.

At least one of the inner or the outer surface may comprise a porous material. By using a porous material, the surface area of the inner and/or outer surface is increased, improving the performance of reactor. Further, reactants and/or products can pass through the electrode if necessary to exit the reaction zone.

At least one of the inner or outer surfaces may be coated with a porous material.

A wide range of electrochemical reactions may be carried out in the reactor including, but not limited to: electrolysis reactions (for instance of water or of sodium chloride), redox reactions, and the purification of metal ores.

In exemplary embodiments, the anode and/or cathode may be formed as a mesh.

In exemplary embodiments, the reactor may be configured to carry out both photochemical and electrochemical reactions. For example, at least one of the electrodes may be formed of a mesh to permit visible light and/or ultraviolet light and/or infrared radiation to be transmitted to the reaction chamber. For example, the outer surface may comprise an electrode formed of a mesh such that visible light and/or ultraviolet light and/or infrared radiation may be transmitted to the reaction chamber through the gaps in the mesh.

In some embodiments, the mesh may permit electromagnetic radiation of other wavelengths to enter the reaction chamber.

In exemplary embodiments, the inner surface may be provided by an electrode jacket covering a rotor, for example a removable electrode jacket.

The electrode jacket may be impregnated with, or be constructed from, a material or materials desirable for a given chemical reaction, for example, a material or materials which may transfer electrons and/or act as a catalyst or reagent (e.g. a precious metals) in a given reaction.

In the case where the jacket is removable, this provides a more flexible reactor which is readily adaptable to a variety of syntheses, e.g. by interchanging jackets, which is beneficial for industrial applications of the reactor.

According to an aspect of the disclosure, an apparatus for carrying out chemical reactions is provided, the apparatus comprising a first reactor for carrying out a first chemical reaction and a second reactor for carrying out a second chemical reaction, wherein each reactor comprises:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which a reaction product can leave the reaction chamber,
wherein the outlet of the first reactor is coupled to the inlet of the second reactor.

In other words, the first and second reactors are linked together in series. In this way, the reaction products of the chemical reaction carried out in the first reactor are all or some of the reagents for the chemical reaction carried out in the second reactor. In addition it is possible for reagents to be added to the reaction stream traveling between the one reactor and the next facilitating production of new reaction products. Additional pumps may be required to facilitate this addition of reagents,

In this way, two or more reactors can be linked together to carry out sequential reactions or reaction phases. Each reactor can be configured to provide different reaction conditions corresponding to the particular reaction or phase being carried out. Accordingly, each reaction or phase can be optimised.

Reactors having different reaction conditions can be coupled together in the sequence required for a particular reaction or series of reactions.

As discussed above, the flow rate through the reactor is decoupled from the extent of mixing achieved within the reactor. Therefore a single flow rate can be achieved throughout a plurality of reactors which are operating at different residence times. The required amount of mixing can be tailored for a given reactor, without needing to alter the flow rate through the reactor. In this way, reaction fluid can flow through the plurality of reactors at the same flow rate, whilst each reactor is configured to achieve an amount of mixing required for the particular reaction/reaction phase carried out. The amount of mixing can also be controlled by varying a gap size between the inner and outer surface of a particular reactor. In this way, the extent of mixing is independent of the flow rate.

The volume of the reaction chamber of a particular reactor can be selected based on the residence time required for the particular reaction or phase of reaction taking place in said reactor. In this way, the residence time in a particular reactor is independent of the flow rate and is independent of the extent of mixing.

The outlet of the first reactor may be connected to the inlet of the second reactor via a fluid conduit.

In some embodiments, a pump is provided in the fluid conduit to pump products from the first reactor into the inlet of the second reactor.

In this way, a flow path is formed from the inlet of the first reactor to the outlet of the second reactor, via the reaction chambers of the first and second reactors.

The first and/or second reactors may be configurable such that the speed of relative rotation in the first reactor is the same as or different from the speed of relative rotation in the second reactor.

In this way, the extent of mixing in the respective reactor can be changed as desired. The extent of mixing in each reactor can be tailored for a particular reaction, without varying the flow rate through the plurality of reactors and/or the residence time in each reactor.

The apparatus may be configurable such that a flow rate of fluid from the outlet of the first reactor is equal to the flow rate of fluid into the inlet of the second reactor, for example, the apparatus comprises a pump for pumping fluid through the plurality of reactors at a constant flow rate.

In other words, the apparatus is configured such that a constant flow rate through the plurality of reactors is permitted. Since flow rate is decoupled from mixing in the reactors described herein, variation of mixing and/or residence time can still be adjusted for each reactor as desired.

In some embodiments, additional reagents are introduced between the first and second reactors. Accordingly, the flow rate in the second reactor may be faster than the flow rate in the first reactor.

The apparatus may comprise a third reactor for carrying out a third chemical reaction, wherein the third reactor is provided in series with the first and second reactors, and/or is provided in parallel with the first and/or second reactor.

Any number of reactors may be coupled together for a given reaction or sequence of reactions.

In some embodiments, the apparatus comprises more than three reactors. In exemplary embodiments, the apparatus comprises 4, 5, 6, 7, 8, 9, 10 or more reactors. These may be coupled together in parallel and/or series, or a combination.

In some embodiments, one or more of the chemical reactions is a photochemical reaction, an electrochemical reaction and/or a thermal reaction.

For example, the first reactor may be configured for carrying out a photochemical reaction and the second reactor may be configured for carrying out an electrochemical reaction. An inlet of a third reactor may be coupled to the outlet of the second reactor and the third reactor may be configured for carrying out a thermal reaction. An inlet of a fourth reactor may be coupled to the outlet of the third reactor and the fourth reactor may be configured for carrying out an electrochemical reaction.

For example the first reactor may be configured for carrying out a photochemical reaction and the second reactor may be configured for carrying out an electrochemical reaction. The outlet of the second reactor may be couple to the inlets of a third and fourth reactor, each of which may be configured for carrying out a photochemical reaction, an electrochemical reaction and/or a thermal reaction.

According to a further aspect of the disclosure, an apparatus for carrying out chemical reactions is provided, the apparatus comprising a first reaction zone for carrying out a first chemical reaction and a second reaction zone for carrying out a second chemical reaction, wherein each reaction zone comprises:
a. an inner surface and an outer surface which are spaced apart from each other to define a reaction volume configured such that, in use, a respective chemical reaction takes place in the reaction volume, and wherein the inner surface and outer surface are configured for relative rotation with respect to each other,
b. an inlet for introduction of a reagent to the reaction volume, and
c. an outlet through which a reaction product can leave the reaction volume,
wherein the reaction products of the first reaction zone comprise reagents of the second reaction zone.

In this way, two or more reactors/reaction zones can be linked together to carry out sequential reactions or reaction phases. Each reactor/reaction zone can be configured to provide different reaction conditions corresponding to the particular reaction or phase being carried out. Accordingly, each reaction or phase can be optimised.

It will be understood that each reaction zone comprises a discrete reaction region, comprising a reaction volume in which the respective chemical reaction takes place.

Reactors/reaction zones having different reaction conditions can be coupled together in the sequence required for a particular reaction or series of reactions.

In exemplary embodiments, the reaction zones are provided by regions of a single reactor. In exemplary embodiments, each reaction volume comprises a portion of a reaction chamber of the single reactor, said portion defined by said inner and outer surfaces.

In exemplary embodiments, the rotor comprises a jacket having properties desired for a particular reactor/reaction zone. For example, the jacket may have zones of different properties corresponding to the reaction zones.

In some embodiments, additional reagents are introduced between the first and second reaction zones.

The apparatus may comprise a third reaction zone for carrying out a third chemical reaction.

In some embodiments, one or more of the chemical reactions is a photochemical reaction, an electrochemical reaction and/or a thermal reaction.

Any number of reactors/reaction zones may be coupled together for a given reaction or sequence of reactions.

In some embodiments, the apparatus comprises more than three reactors/reaction zones. In exemplary embodiments, the apparatus comprises 4, 5, 6, 7, 8, 9, 10 or more reactors/reaction zones. In the case of reactors, these may be coupled together in parallel and/or series, or a combination.

For example, the reaction zone may be configured for carrying out a photochemical reaction and the second reaction zone may be configured for carrying out an electrochemical reaction. A third reaction zone may be configured for carrying out a thermal reaction. A fourth reaction zone may be configured for carrying out an electrochemical reaction.

By way of example, the apparatus may be used to prepare antimalarial drug, artemisinin. In this reaction there is a first stage which is photochemical and should be carried out at low temperature. This is followed by a second stage in which the temperature can be varied. An acid catalyst can be added at either the first or second stages. The apparatus described herein may include a first reactor/reaction zone, configured for photochemical reactions, for carrying out the first stage, and a second reactor/reaction zone for carrying out the second stage.

It will be appreciated that apparatus disclosed herein may comprise any suitable combination of reactors/reaction zones.

The outer surface of one or more of the reactors/reaction zones may be formed of a material which permits electromagnetic radiation of a desired wavelength to be transmitted to the respective reaction chamber/reaction volume.

In some embodiments, the desired wavelength corresponds to an optimal wavelength for a given reaction, e.g. photochemical reaction. Therefore, transmitting electromagnetic radiation at this wavelength to the reaction vessel will increase the efficiency and optimise the reaction.

In some embodiments, the outer surface of at least one reactor/reaction zone permits radiation of a first desired wavelength to be transmitted, and the outer surface of at least one other reactor/reaction zone permits radiation of a second desired wavelength to be transmitted, wherein the first and second wavelengths are the same or different.

In this way, the reactor(s) can be tailored for particular reactions, e.g. photochemical reactions.

The outer surface of at least one reactor/reaction zone may permit visible light and/or ultraviolet light and/or infrared radiation to enter the reaction chamber/reaction volume. For example, the outer surface comprises transparent or translucent material such that visible light and/or ultraviolet light and/or infrared radiation can enter the reaction chamber/reaction volume.

The apparatus may further comprise an electromagnetic radiation source, e.g. a visible light and/or ultraviolet light and/or infrared radiation source.

The gap size between the inner surface and the outer surface of one or more of the reactors may be in the range 1 and 6 mm. For, example, up to 6 mm, for example 0.5, 1, 2, 3, 4, 5 or 6 mm. For example, the gap size may be up to 6 mm, e.g. in the range of 1 and 6 mm, for a rotor diameter of 20 mm.

In embodiments where one or more of the reactors is configured for carrying out photochemical reactions, the gap size between the inner surface and the outer surface may be about 3 mm.

In some embodiments, the inner and outer surfaces of at least one reactor are configured as electrodes and wherein the chemical reaction is an electrochemical reaction.

In an aspect disclosed herein, a kit of reactors is provided, comprising a plurality of reactors which can be reconfigured as necessary for a desired reaction or reactions.

In exemplary embodiments, the outer surface of the reaction chamber/reaction volume is provided by an outer wall of the reaction vessel.

In exemplary embodiments, the outer surface of the reaction chamber/reaction volume is provided by a jacket covering the outer wall of the reaction vessel.

In exemplary embodiments, the jacket is configured to permit electromagnetic radiation to be transmitted to the reagents in the reaction chamber/reaction zone (e.g. optically transparent). In exemplary embodiments, the jacket is configured to act as an electrode. In exemplary embodiments, the jacket may be configured to be heated/cooled to heat/cool the reagents. It will be appreciated that the jacket may be configured to perform all or some of these functions, in any combination.

In some embodiments, the reaction vessel comprises a single vessel, for example having multiple reaction zones, in which different reactions/stages of a reaction can be carried out. In exemplary embodiments, different jackets can be used to provide the outer surface of the reaction volume for a given reaction zone.

### BRIEF DESCRIPTION OF THE DRAWINGS

Embodiments disclosed herein will now be described, by way of example only, with reference to the accompanying drawings, in which:

FIG. 1 shows a schematic illustration of an apparatus according to an embodiment of this disclosure comprising three reactors;

FIG. 2 shows a schematic illustration of how reactors according to embodiments of this disclosure can be coupled together;

FIG. 3 shows a schematic illustration of a reactor according to an embodiment of this disclosure configured for a photochemical reaction;

FIG. 4 shows a perspective view of the reactor of FIG. 3;

FIG. 5 shows a schematic of an alternative embodiment of a reactor of this disclosure;

FIG. 6 shows a schematic illustration of a reactor according to an embodiment of this disclosure configured for an electrochemical reaction,

FIG. 7 shows a schematic illustration of a reactor according to an embodiment of this disclosure and configured for electrochemical and/or photochemical reactions,

FIG. 7a shows a schematic illustration of a reactor according to an embodiment of this disclosure and configured for electrochemical and/or photochemical reactions,

FIG. 8 illustrates the reaction mechanism for Example 1,

FIG. 9 shows a schematic illustration of a reactor according to an embodiment of this disclosure comprising a plurality of reaction zones, and

FIG. 10 illustrates the permutations of 2, 3 and 4 reactor/reactor zones couple in series.

### DETAILED DESCRIPTION

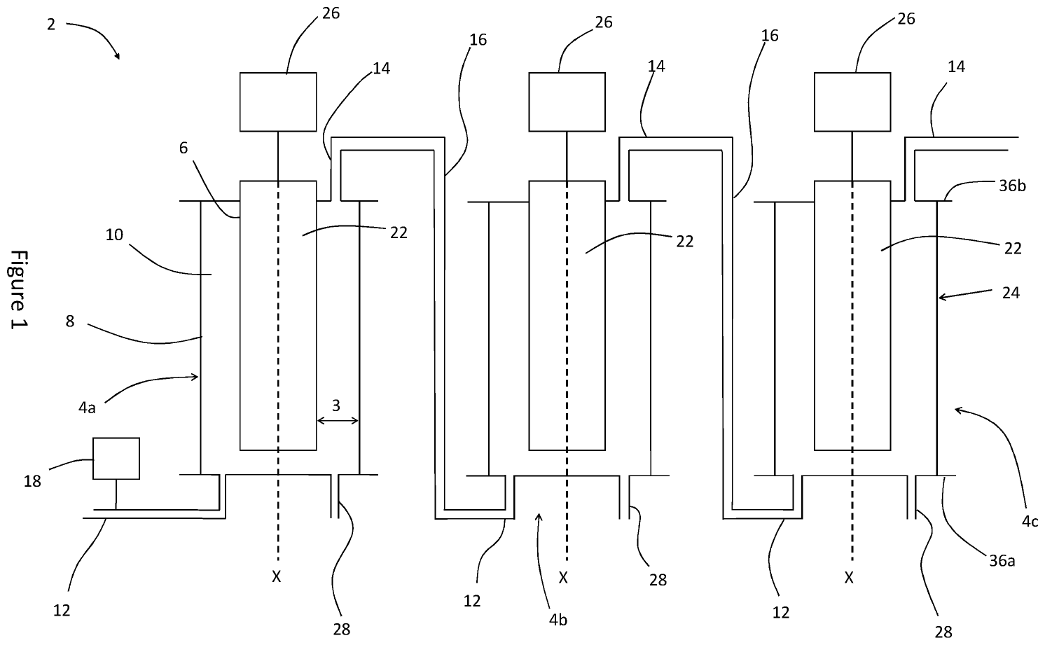

With reference to FIG. 1, an apparatus for carrying out chemical reactions is generally indicated at reference numeral 2. The apparatus 2 comprises a first reactor 4a for carrying out a first chemical reaction, a second reactor 4b for carrying out a second chemical reaction, and a third reactor 4c for carrying out a third chemical reaction.

Each reactor includes an inner surface 6 and an outer surface 8 which are spaced apart from each other by a gap distance g to define a reaction chamber 10.

Each reactor also includes an inlet 12 through which reagents are introduced to the reaction chamber 10. Each reactor also includes an outlet 14 through which reaction products leave the reaction chamber 10.

As is illustrated in FIG. 1, the outlet 14 of the first reactor 4a is coupled to the inlet 12 of the second reactor 4b via a fluid conduit 16, e.g. a pipe. Similarly, the outlet 14 of the second reactor 4b is coupled to the inlet 12 of the third reactor 4c via a fluid conduit 16, e.g. a second pipe.

In each of the reactors 4a, 4b, 4c, the inner surface 6 and the outer surface 8 are configured for relative rotation with respect to each other. Each of the first, second and third reactors 4a, 4b, 4c is configurable such that the speed of relative rotation may be tailored to meet a particular reaction requirement. Accordingly the speed of relative rotation of the first reactor 4a, the second reactor 4b and the third reactor 4c may be the same as or different from each other.

As will be appreciated with reference to FIG. 1, a continuous flow path is provided from the inlet 12 of the first reactor 4a to the outlet 14 of the third reactor 4c, via the reaction chambers 10 of each of the three reactors 4a, 4b, 4c. The apparatus 2 of the embodiment illustrated in FIG. 1 further comprises a pump 18 for pumping fluid through the first, second and third reactors 4a, 4b, 4c at a constant flow rate.

With reference to FIGS. 1, 3 and 6, the reactors 4a, 4b and 4c are shown in cross section. The inner surface 6 is defined by a rotor 22, which is configured to rotate with respect to the outer surface 8 of the reaction chamber 10. Each reactor also includes a cylindrical reaction vessel 24 which defines the outer surface 8 of the reaction chamber 10. The rotor 22 extends into the reaction vessel 24. The rotor 22 also comprises a cylindrical profile. Accordingly, an annular reaction chamber 10 is defined by the space between the inner and outer surfaces 6, 8.

In exemplary embodiments, the inner and outer surfaces 6, 8 define concentric cylindrical surfaces. The rotor 22 of each reactor 4a, 4b, 4c is coupled to a motor 26 which controls rotation of the rotor 22 within the reaction vessel 24. As illustrated in FIG. 1, each reactor, hence each rotor 22, is coupled to a separate motor such that the rotation of each rotor 22 in the reactors 4a, 4b, 4c can be controlled independently.

The reactor may be made of a metallic material, or may be made of a plastics material e.g. PEEK, which is more lightweight.

In exemplary embodiments, the diameter of the outer surface 8 is approximately 10 cm.

In exemplary embodiments, the rotor 22 of a given reactor 4a, 4b, 4c may rotate at a speed in the range of 50-5,000 rpm, e.g. 4,000 rpm. The rotor 22 is configured to rotate about a longitudinal axis X of the respective reactor. The rotor 22 also comprises a longitudinal axis which is co-axial with the longitudinal axis X of the reactor.

In the embodiments illustrated in FIGS. 1, 3 and 6, each reactor includes a gas inlet 28 for introducing gas into the reaction chamber 10.

In the embodiments illustrated in FIGS. 1, 3 and 6, the inlet 12 is provided towards the bottom end of the reactor 4a, 4b, 4c and the outlet 14 is provided towards the top end. In this way, reaction fluid flows from the bottom of the reactor 4a, b, c to the top. It will be appreciated that the reactor(s) could be arranged to have the inlet 12 at the top of the reactor and the outlet at the bottom.

In the embodiments illustrated in FIGS. 1, 3 and 6, the reaction vessel 24 comprises upper and lower flanges 36a, b, which project radially from the lower and upper ends, respectively, of the vessel 24 to form a pair of flat rings. Further, the reaction vessel 24 includes an open top and open bottom.

In this way, the reaction vessels can easily be stacked to create a larger reactor or to perform a series of reactions as the reaction fluid flows directly through the stacked reaction vessels. In such an arrangement, the open top or bottom is the inlet or outlet of the reactor. In such embodiments the reaction vessels may share a common rotor.

In the embodiments illustrated in FIGS. 1, 3 and 6, it will be appreciated that the top and bottom of the reaction vessel 24 are both sealed to prevent ingress of air from the atmosphere.

With reference to FIGS. 1, 3 and 6, when apparatus 2 is in use, starting materials SM are introduced to reactor 4a via its inlet 12. These are pumped into the reaction chamber 10 via pump 18. The motor 26 controls the rotor 22 to rotate in the reaction vessel 24. Optionally, gas reagents are introduced to the reaction chamber 10 via gas inlet 28.

As the rotor 22 rotates, Taylor vortices 32 are generated in the reaction chamber 10. These are toroidal vortices threaded around the central rotor 22. The reaction fluid moves through the reaction chamber 10 from the inlet 12 to the outlet 14. Reaction products leave the reaction chamber 10 via the outlet 14 and flow through the fluid conduit 16 to the inlet 12 of the next reactor 4b. The process is repeated for the second and third reactors 4b, 4c.

The first, second and third reactors 4a, 4b, 4c may be suitable for an electrochemical reaction, a photochemical reaction and/or a thermal reaction, for example.

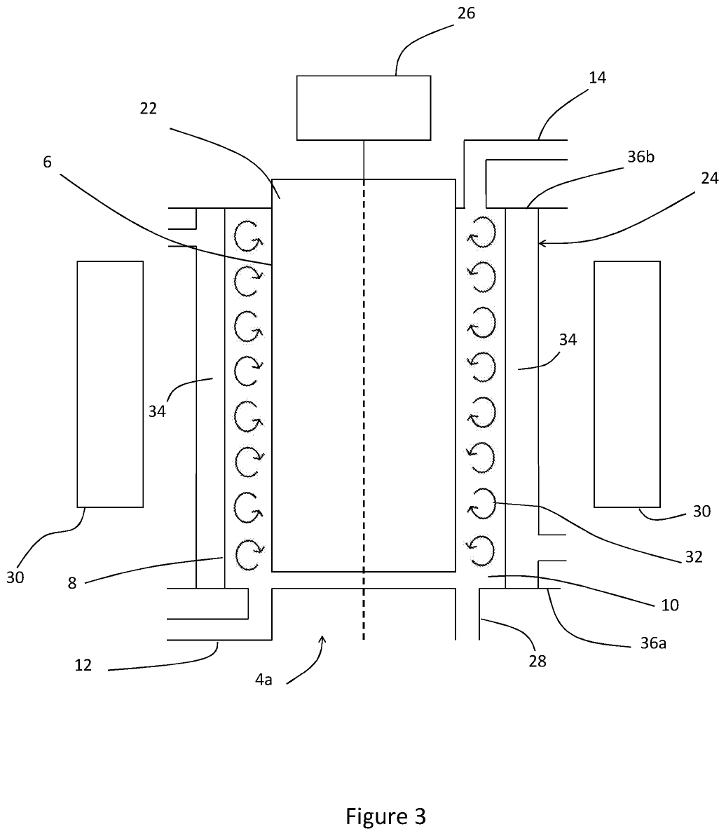

In the illustrated embodiment shown in FIG. 3, the first reactor 4a is configured for carrying out photochemical reactions. With reference to FIG. 1, this is the first reactor in the series, but could be any of the first, second, third or further reactors. One or more of the chemical reactions carried out by the reactors 4a, 4b, 4c of apparatus 2 may be a photochemical reaction, an electrochemical reaction and/or a thermal reaction.

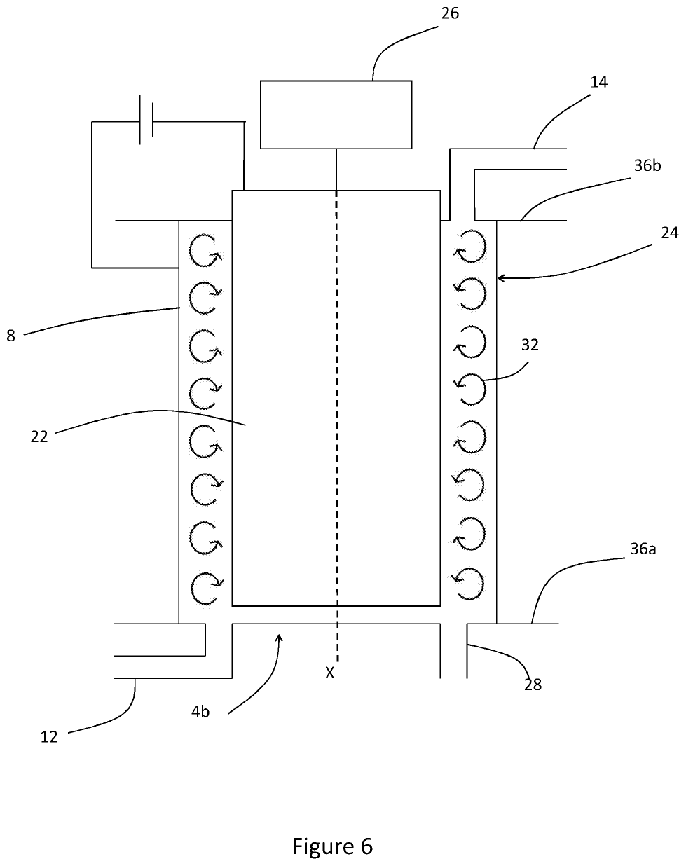

With reference to FIG. 6, the second reactor 4b is configured for carrying out electrochemical reactions. With reference to FIG. 1, this is the second reactor in the series, but could be any of the first, second or third reactors.

It will be appreciated that the apparatus may include more than three reactors.

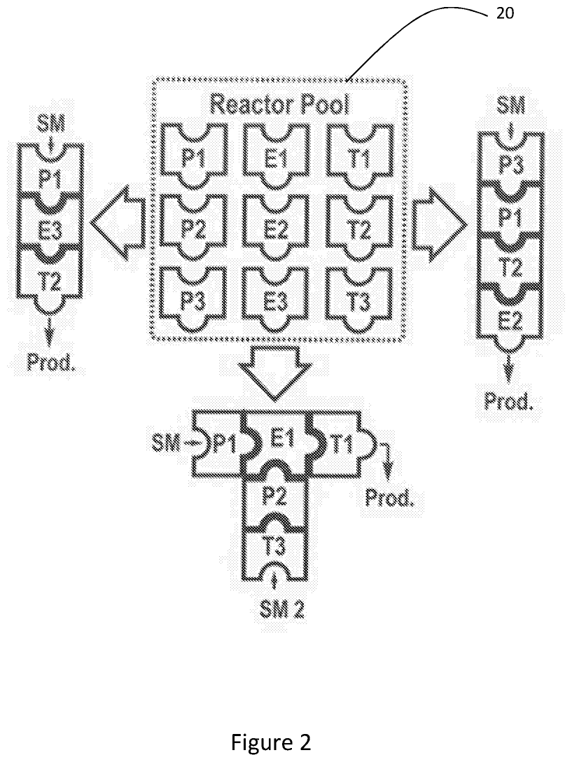

With reference to FIG. 2, exemplary configurations of reactors are illustrated. In FIG. 2, reactors configured for photochemical reactions are indicated as P1, P2 and P3, reactors configured for carrying out electrochemical reactions are indicated as E1, E2 and E3, and reactors configured for carrying out thermal reactions are indicated as T1, T2 and T3. Three exemplary arrangements are illustrated in FIG. 2. Of course it will be appreciated that any suitable arrangement of reactors will be possible, as desired.

A reactor pool 20 is provided which includes reactors P1, P2, P3, E1, E2, E3, T1, T2 and T3. In other words three reactors configured for carrying out photochemical reactions, three reactors configured for carrying out electrochemical reactions and three reactors configured for carrying out thermal reactions. It will be appreciated that any number of reactors may be included in the pool.

To the left of the reactor pool an apparatus comprising three reactors is illustrated. These are P1, E3 and T2. Starting materials SM are input to the first reactor P1 via its inlet 12. Products of the photochemical reaction carried out in P1 pass from the outlet of P1 to the inlet of E3. In E3, an electrochemical reaction is then carried out. The products of the reaction carried out in E3 leave E3 via its outlet 14 and flow to the inlet 12 of reactor T2. A thermal reaction is carried out in reactor T2 and the products of this exit the reactor via its outlet 14. This example illustrates an apparatus having three reactors coupled together in series. To the right of the reactor pool 20 shown in FIG. 2, an exemplary apparatus comprising four reactors is illustrated. These are coupled together in series in a similar manner as previously described.

Below the reactor pool 20 shown in FIG. 2, a third exemplary configuration is illustrated. This comprises five reactors coupled together, partly in series and partly in parallel. In this arrangement, the reaction products of P1 and the reaction products of P2 are both input as reagents to the reactor E1. An electrochemical reaction is carried out in E1 and the reaction products passed to T1 where a thermal reaction is then carried out. It will be appreciated that any desired configuration of reactors may be used.

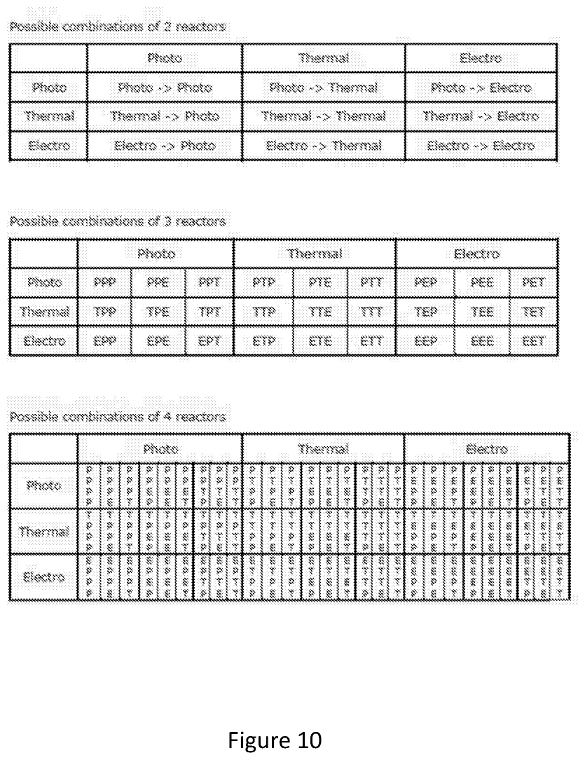

Possible combinations of 2, 3 and 4 reactors are shown in FIG. 10, where “P” or “Photo” denotes a reactor configured for carrying out photochemical reactions, “E” or “Electro” denotes a reactor configured for carrying out electrochemical reactions, and “T” or “Thermal” denotes a reactor configured for carrying out thermal reactions.

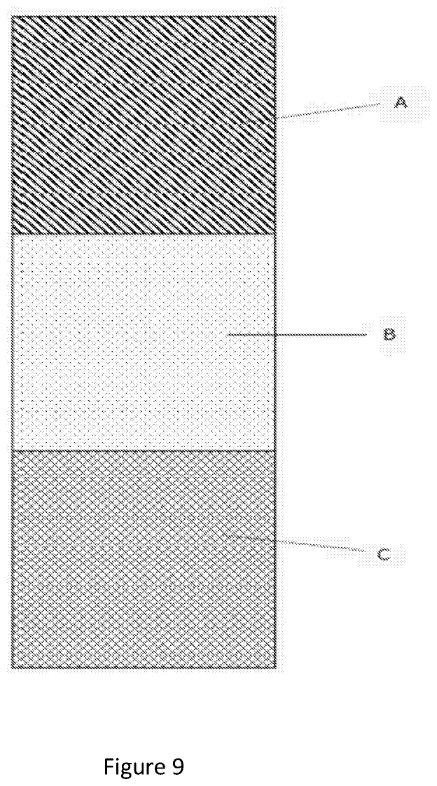

Of course, it will be appreciated that, rather than a plurality of reactors being provided and coupled together in series, a single reactor with a plurality of reaction zones may be provided, as shown in FIG. 9. First, second and third reaction zones are indicated by reference numerals A, B and C respectively. It will be appreciated that zones A, B and C can be configured for any of electrochemical, photochemical and thermal reactions. Each reaction zone comprises a corresponding reaction volume in which the respective reaction takes place. In the illustrated embodiment, the reaction zones A, B and C are provided by discrete portions of a single reactor, and the respective reaction volumes are provided by corresponding discrete portions of the reaction chamber.

With reference to FIG. 3, a reactor 4b for photochemical reactions is shown. In addition to the reactor features previously described, the outer surface 8 of the reactor 4a is formed of a material which permits visible light to enter the reaction chamber 10. This may be a particular wavelength of visible light or a broader bandwidth.

In exemplary embodiments, reactors disclosed herein may include an outer surface 8 which is formed of a material which permits electromagnetic radiation, e.g. of a desired wavelength, to be transmitted to the reaction chamber.

It will be appreciated that, in such embodiments, the reaction vessel, or at least a portion thereof, must also permit electromagnetic radiation e.g. visible light, to enter the reaction chamber.

In the case where an apparatus includes more than one reactor/reactor zone for photochemical reactions, the outer surface 8 of at least one reactor/reactor zone may permit radiation of a first desired wavelength to be transmitted to the reaction chamber/reaction volume and the outer surface of at least one other reactor/reactor zone may permit radiation of a second desired wavelength to be transmitted to the second reaction chamber/reaction volume, wherein the first and second wavelengths are the same or different.

With reference to FIG. 3 the reactor 4a (or apparatus 2) also includes a light source 30. In exemplary embodiments this may be an array of white LEDs of 360 watts each. Alternatively any type or power of LED or other light source can be used. Further any number of arrays or any number of light sources may be used, e.g. 1, 2, 3, 4, 5, 6 or more.

In exemplary embodiments, the reactor or apparatus may include an electromagnetic radiation source.

The gap size g between the inner surface 6 and the outer surface 8 is typically up to 6 mm, e.g. in the range of 1-6 mm, for a rotor diameter of 20 mm. In the case of photochemical reactions, it has been found that a gap size of approximately 3 mm is optimal.

As illustrated in FIG. 3, the reactor includes a jacketed reaction vessel 24. This is illustrated in relation to a reactor 4a which is configured for photochemical reactions, but may also be used for other reaction types e.g. thermal reactions. In the embodiment shown in FIG. 3, the reaction vessel 24 is a double walled reaction vessel having a volume 34 through which heating or cooling fluid can be circulated to control the temperature of reaction fluid flowing through the reactor.

As will be appreciated, this is particularly advantageous for thermal reactions, although can equally apply to other types of reaction.

In exemplary embodiments, the jacket 34 is configured to permit electromagnetic radiation to be transmitted to the reagents in the reaction chamber/reaction volume (e.g. optically transparent for photochemical reactions). In exemplary embodiments, the jacket 34 is configured to act as an electrode (e.g. for electrochemical reactions—described in more detail below). It will be appreciated that the jacket 34 may be configured to perform all or some of these functions, in any combination.

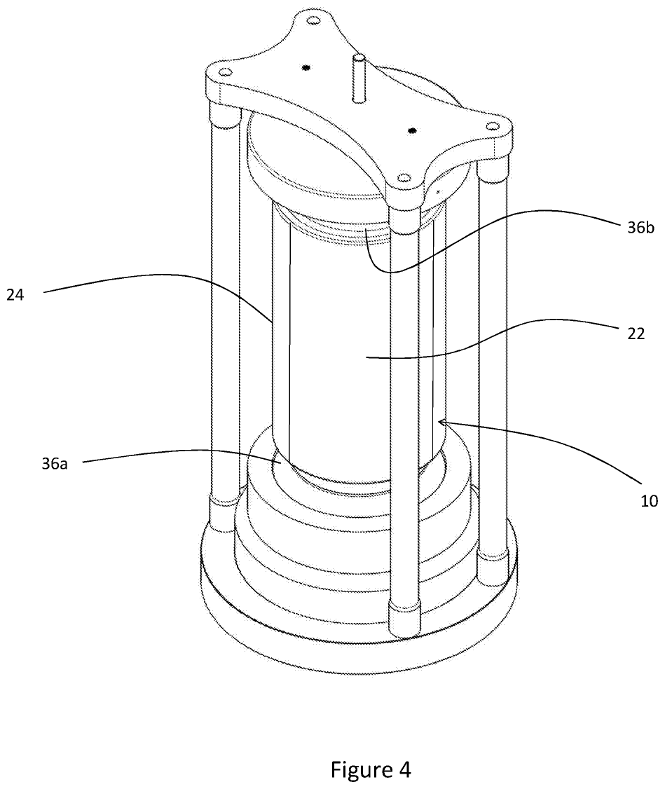

FIG. 4 illustrates the embodiment of FIG. 3 in perspective view.

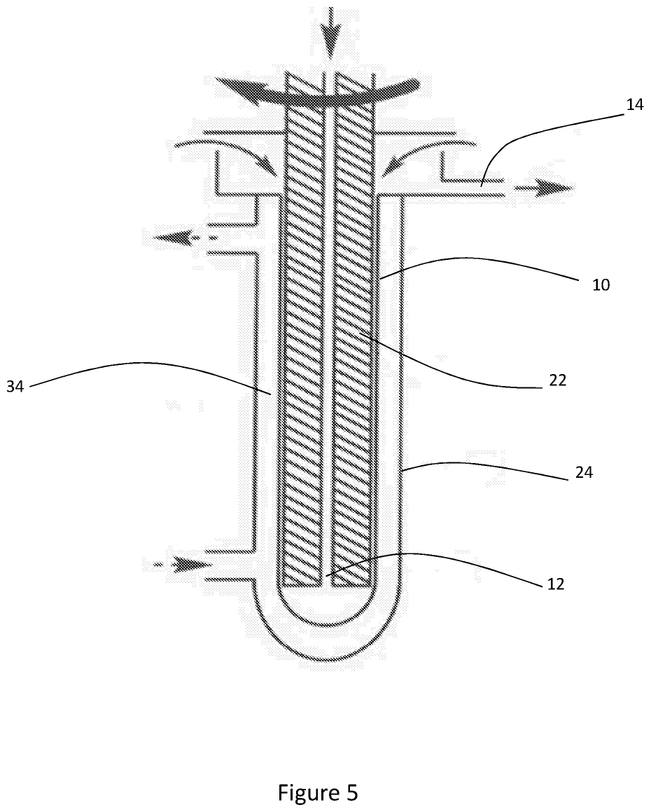

With reference to FIG. 5 an alternative embodiment of reactor is illustrated. In the illustrated embodiment, the inlet 12 comprises a bore through the centre of the rotor 22 such that reactants are introduced at the bottom of the reaction chamber 10. The rotor 22 is supported at its upper end.

Further, the reaction vessel 24 is an open topped vessel such that the reaction fluid is in contact with the air. In this way air can be drawn into the reaction fluid as the reaction is carried out. Also reaction products can be drawn from the top of the reaction fluid e.g. using a pump.

The embodiment shown in FIG. 5 can be adapted for any type of reaction, for example photochemical, electrochemical or thermal, in a similar manner as described herein in relation to FIGS. 3 and 6.

With reference to FIG. 6, a reactor 4b is shown which is configured for electrochemical reactions. In this embodiment, the inner surface 6 and the outer surface 8 are configured as electrodes.

In this reactor the inner surface is the cathode and the outer surface the anode and the cathode may be copper and the anode zinc in an electrolyte of sodium chloride solution. The gap size is 1.0 mm±0.1 mm. Alternatively, the gap size is up to 0.5 mm, e.g. 0.5 mm±0.1 mm. The rotor 22 is securely supported at its upper end for rotation about its longitudinal axis. Given the small gap size between the inner and outer surfaces 6,8, the coupling between the motor 26 and the rotor 22 is configured to reduce lateral movement of the rotor 22, e.g. the coupling is machined and manufactured to strict tolerances. In this way, lateral movement between the anode and the cathode is minimised to prevent short circuiting of the system.

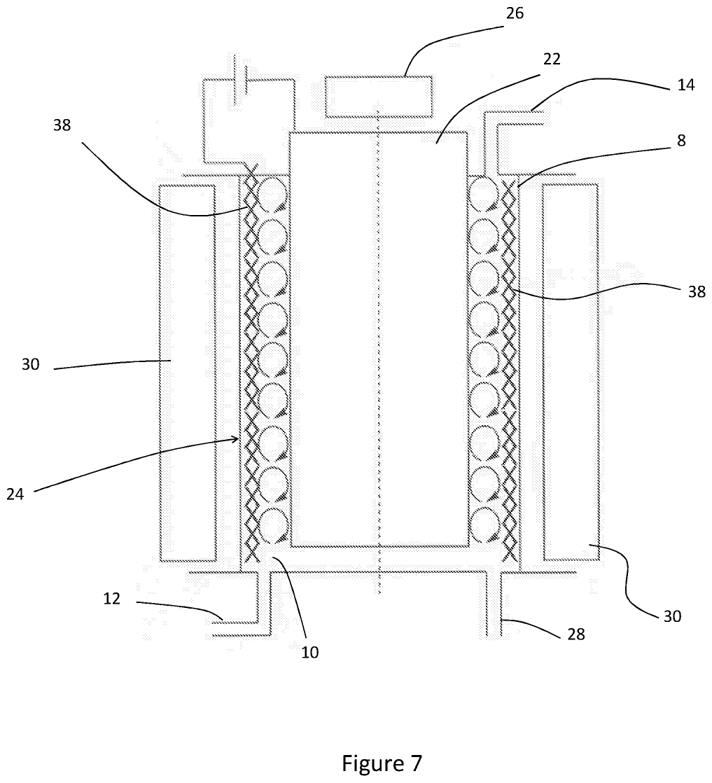

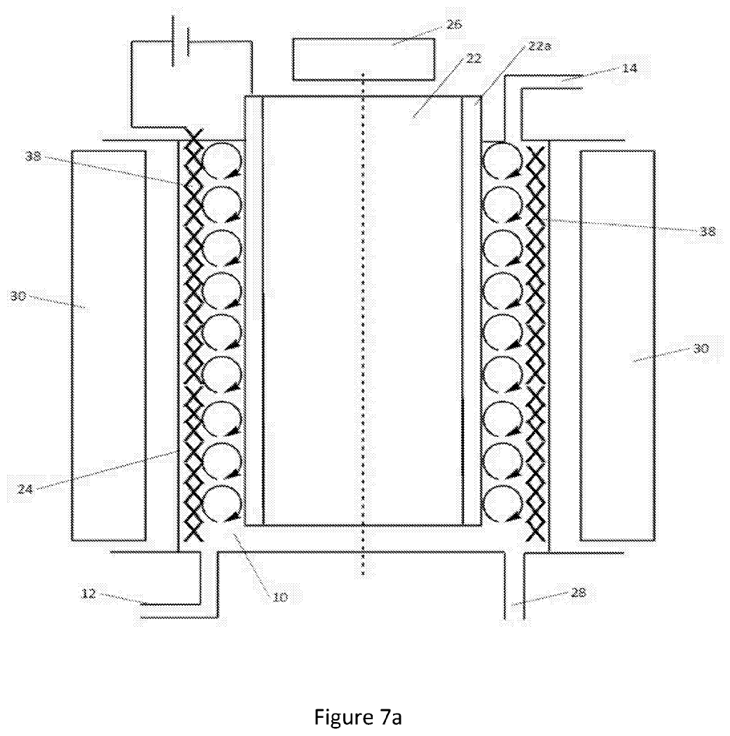

With reference to FIG. 7, an alternative embodiment of reactor is illustrated. This reactor is configured for electrochemical and/or photochemical reactions. In this reactor, the outer wall of the reaction vessel 24 comprises a mesh material 38, which is configured to permit visible light and/or ultraviolet light and/or infrared radiation to enter the reaction chamber 10 via gaps in the mesh 38. The mesh 38 is also configured as an electrode, so that the reactor is configured for electrochemical reactions. In the embodiment of FIG. 7, the mesh 38 is the anode. In alternative embodiments, the mesh is the cathode.

With reference to FIG. 7a, an alternative embodiment of the reactor is illustrated. This reactor is the same as that shown in FIG. 7, with the exception that the inner surface electrode is provided by a jacket 22a fitted to the rotor 22. The electrode jacket 22a is removable and is configured to cover the outer surface of the rotor 22 when fitted to the rotor 22.

In this way, the rotor 22 does not need to be made of a particular material required by a given reaction. Instead, an electrode jacket 22a of the required material can be used.

Examples of the use of reactors and apparatuses disclosed herein will now be detailed.

### Example 1a

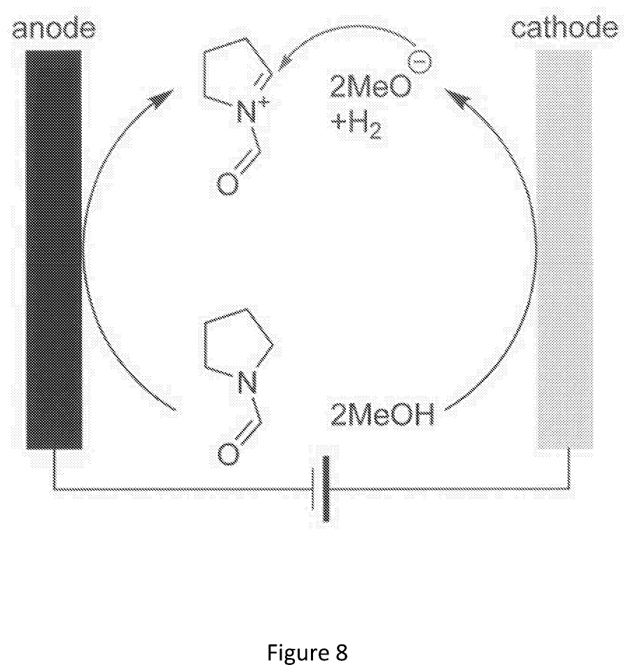

An electrochemical reaction was carried out using a reactor disclosed herein. Specifically, the methoxylation of N-formyl pyrrolidine, according to the reaction equation below and mechanism illustrated in FIG. 8:

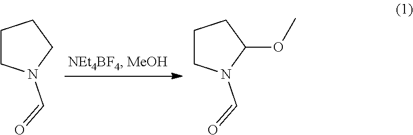

Reaction mixture included 0.1 M N-formyl pyrrolidine. The electrolyte was NEt₄BF₄ in Methanol.

Flow rate through the reactor was 6.25 mlmin⁻¹, with a residence time of approximately 2 minutes. Reactor volume was 12.5 ml within this example. A constant current was applied across the electrodes with a voltage of 12 V.

The results of this reaction are detailed in Table 1 below. “Rotation Speed” is the rotation speed of the rotor. “Conversion” is the consumption of N-formyl pyrrolidine, “Yield” is the amount of N-formyl-2-methoxypyrrolidine produced. Both were measured by 1H NMR using biphenyl as an external standard.

“Productivity” per hour was calculated by the following equation:

Productivity (gh⁻¹)=((Flow rate×60×concentration)/1000)×129.16×yield (2)

Productivity per day was calculated as productivity per hour multiplied by 24.

For the reactions with no relative rotation between the inner and outer surfaces of the reactor (entry 4 and 9) a double methoxylated product was observed due to over-oxidation. In entry 4 there was approximately 3% of N-formyl-2,5-dimethoxypyrrollidine, and at entry 9 there was 5% N-formyl-2,5-dimethoxypyrrollidine.

TABLE 1
Resusts of example 1a

| | Rotation | Electrolyte | | | | | |
|---|---|---|---|---|---|---|---|
| | Speed | Concentration | Current | Conversion | Yield | Productivity | Productivity |
| Entry | (RPM) | (mM) | (A) | (%) | (%) | (g h⁻¹) | (g day⁻¹) |
| 1 | 4000 | 50 | 0.5 | 32 | 17 | 0.8 | 19.2 |
| 2 | 4000 | 50 | 1.0 | 68 | 36 | 1.7 | 40.8 |
| 3 | 4000 | 50 | 2.0 | 93 | 73 | 3.5 | 84.0 |
| 4 | 0 | 50 | 2.1 | 67 | 54 | 2.6 | 62.4 |
| 5 | 1000 | 50 | 2.1 | 92 | 77 | 3.7 | 88.8 |
| 6 | 2000 | 50 | 2.1 | 93 | 79 | 3.8 | 91.2 |
| 7 | 3000 | 50 | 2.1 | 91 | 82 | 4.0 | 96.0 |
| 8 | 4000 | 50 | 2.1 | 90 | 84 | 4.1 | 98.4 |
| 9 | 0 | 50 | 3 | 90 | 70 | 3.4 | 81.6 |
| 10 | 1000 | 50 | 3 | >99 | 90 | 4.4 | 105.6 |
| 11 | 2000 | 50 | 3 | >99 | 89 | 4.3 | 103.2 |
| 12 | 3000 | 50 | 3 | >99 | 92 | 4.5 | 108.0 |
| 13 | 4000 | 50 | 3 | >99 | 96 | 4.6 | 110.4 |
| 14 | 4000 | 25 | 3 | 98 | 90 | 4.4 | 105.6 |
| 15 | 4000 | 100 | 3 | 98 | 96 | 4.6 | 110.4 |

From this it can be seen that whilst excellent conversions and yields are observed under all conditions, increasing both current and rotation speed enhance these properties of the reaction.

### Example 1b

Similar to Example 1a, an electrochemical reaction was carried out using a reactor disclosed herein. Specifically, the methoxylation of N-formyl pyrrolidine, according to the reaction equation (1) above and mechanism illustrated in FIG. 8.

N-formylpyrrolidine (0.992 g, 10 mmol) and tetrabutylammonium tetrafluoroborate (NEt₄BF₄, 1.086 g, 5 mmol) were dissolved in methanol (100 mL), with sonication to aid dissolution.

An inlet pump was primed with the reaction mixture and the flow rate set at 6.25 mLmin⁻¹, with a residence time of approximately 2 minutes. An outlet pump, provided at the reactor outlet, was set to a speed greater than the inlet flow rate plus the volume of H₂ generated per minute. Typically the outlet pump was set to a speed of about 600 rpm.

The power supply was set to constant current mode with a voltage of 12 V. The rotation speed of the reactor was set to the desired speed.

To begin the reaction, the output of the power supply was turned on and the inlet and outlet pumps were started. Once the solution began to exit the reactor (after approximately 2 min), 3 reactor volumes were passed through the reactor (i.e. over 6 minutes) to reach equilibration before a sample was collected for analysis.

Once the sample collection was complete, the power supply output was turned off. The inlet pump was primed with methanol and the reactor was flushed for 5 reactor volumes (10 minutes at a flow rate of 6.25 mL min⁻¹). The reactor was then drained of excess methanol from the inlet port.

Analysis of the reaction product included NMR analysis, gas chromatography analysis and high resolution mass spectrometry to identify the methoxylated product.

For NMR analysis, 1 mL of the solution from the reactor was taken and biphenyl (0.5 mL of 0.2 M in MeOH) was added and then then methanol was removed by rotary evaporation. The resulting slurry was then re-dissolved in MeOD (0.7 mL) and put into an NMR tube for analysis.

For Gas Chromatography analysis, 1 mL of the solution from the reactor was taken and biphenyl (0.5 mL of 0.2 M in MeOH) was added and then methanol removed by rotary evaporation. The resulting slurry was re-dissolved in ethyl acetate (1 mL) and insoluble NEt₄BF₄ was removed by filtration with the remaining solution placed into a sample vial for analysis.

To isolate the product, 100 mL of the solution from the reactor was taken and evaporated to dryness before re-dissolving in ethyl acetate (30 mL). Insoluble NEt₄BF₄ was removed by filtration and the remaining solution was evaporated to dryness to yield a pale-yellow oil. The crude product was then purified using automated flash chromatography (Teledyne CombiFlash, UV-Vis—254 nm, 40 g RediSep gold cartridge with a gradient system of CH₂Cl₂ increasing to 5% MeOH in CH₂Cl₂ over 45 minutes). The first fraction contained the product, which was isolated as a clear colourless oil.

Conversion and Yield were both are measured by ¹H NMR and Gas Chromatography using biphenyl as an external standard. Productivity was calculated using equation (2) above.

The results of this reaction are detailed in table 2 below. For the reactions with no relative rotation of the electrodes (entry 4 and 9 in table 2 below) a double methoxylated product was observed from over-oxidation. At 2.1 A (entry 4) there was approximately 3% yield of the double-methoxylated and 54% yield of the mono-methoxylated products and at 3 A (entry 9) there was approximately 5% yield of the double-methoxylated and 70% yield of the mono-methoxylated products.

For entry 14, the reaction was run with 25 mM of electrolyte (NEt₄BF₄). For entry 15, the reaction was run with 100 mM of electrolyte (NEt₄BF₄).

In all reactions, the rotor used was made of steel and was covered with an electrode jacket. In reactions 1-15 of the reactions detailed in table 2 below, the rotor electrode jacket, was made of graphite, and in reactions 17-20, the rotor electrode jacket was made of C/PTFE (C/PTFE is PTFE filled with carbon at 25% carbon by weight).

TABLE 2
Results of example 1b

| | | Rotor | Electrolyte | Rotation | | | | | |
|---|---|---|---|---|---|---|---|---|---|
| | | Jacket | concentration | Speed | Current | Conversion | Yield | Productivity | Productivity |
| Entry | Rotor | electrode | (mM) | (RPM) | (A) | (%) | (%) | (g h⁻¹) | (g day⁻¹) |
| 1 | Steel | Graphite | 50 | 4000 | 0.5 | 32 | 17 | 0.8 | 19.2 |
| 2 | Steel | Graphite | 50 | 4000 | 1.0 | 68 | 36 | 1.7 | 40.8 |
| 3 | Steel | Graphite | 50 | 4000 | 2.0 | 93 | 73 | 3.5 | 84.0 |
| 4 | Steel | Graphite | 50 | 0 | 2.1 | 67 | 54 | 2.6 | 62.4 |
| 5 | Steel | Graphite | 50 | 1000 | 2.1 | 92 | 77 | 3.7 | 88.8 |
| 6 | Steel | Graphite | 50 | 2000 | 2.1 | 93 | 79 | 3.8 | 91.2 |
| 7 | Steel | Graphite | 50 | 3000 | 2.1 | 91 | 82 | 4.0 | 96.0 |
| 8 | Steel | Graphite | 50 | 4000 | 2.1 | 90 | 84 | 4.1 | 98.4 |
| 9 | Steel | Graphite | 50 | 0 | 3 | 90 | 70 | 3.4 | 81.6 |
| 10 | Steel | Graphite | 50 | 1000 | 3 | 99 | 90 | 4.4 | 105.6 |
| 11 | Steel | Graphite | 50 | 2000 | 3 | 99 | 89 | 4.3 | 103.2 |
| 12 | Steel | Graphite | 50 | 3000 | 3 | 99 | 92 | 4.5 | 108.0 |
| 13 | Steel | Graphite | 50 | 4000 | 3 | 99 | 96 | 4.7 | 112.8 |
| 14 | Steel | Graphite | 25 | 4000 | 3 | 98 | 90 | 4.4 | 105.6 |
| 15 | Steel | Graphite | 100 | 4000 | 3 | 98 | 96 | 4.7 | 112.8 |
| 16 | Steel | C/PTFE | 50 | 4000 | 0.5 | 32 | 20 | 1.0 | 24.0 |
| 17 | Steel | C/PTFE | 50 | 4000 | 1 | 52 | 39 | 1.9 | 45.6 |
| 18 | Steel | C/PTFE | 50 | 4000 | 2 | 74 | 47 | 2.3 | 55.2 |
| 19 | Steel | C/PTFE | 50 | 4000 | 3 | 57 | 44 | 2.1 | 50.4 |

### Example 2a

A two stage reaction for the production of artemisinin was carried out using two reactors as disclosed herein coupled together in series.

The reaction sequence carried out is illustrated below:

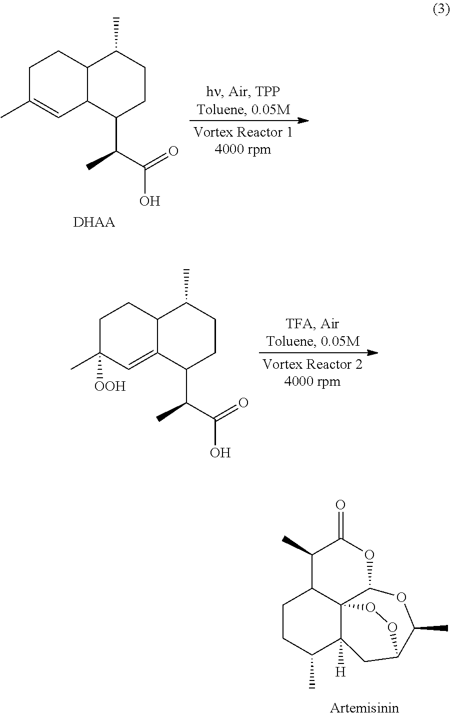

The first step of the reaction was carried out in a first reactor, configured for carrying out photochemical reactions, and the second step of the reaction was carried out in a second reactor. The reaction was carried out under 7 different sets of conditions, as detailed by entries 1-7 in table 3 below.

For entries 1-3 the flow rate through both reactors was at 1 mlmin⁻¹. The reagents included DHAA, TPP and toluene solution (0.05 M) containing 0.025 M TFA (acid). These reagents were all pre-mixed prior to introduction to the first reactor.

For entries 4-7 the flow rate through both reactors was 1 mlmin⁻¹. The reagents included DHAA, TPP and toluene solution, however this time the acid in solution (0.5 M in toluene) and was added to the second reactor using a pump at 0.05 mlmin⁻¹. In this way, the acid was only added to the second stage of the reaction.

TABLE 3
two stage reaction conditions and results

| | Temp. 1^{st} | Temp. 2^{nd} | | |
|---|---|---|---|---|
| | Reactor | Reactor | Acid | Artemisinin |
| Entry | (° C.) | (° C.) | Addition | Yield (%) |
| 1 | 25 | 25 | Pre-mixed at | 45 |
| 2 | 10 | 25 | the beginning | 44 |
| 3 | 5 | 25 | | 45 |
| 4 | 25 | 25 | Added at the | 56 |
| 5 | 10 | 25 | start of the | 55 |
| 6 | 5 | 25 | second | 51 |
| 7 | −15 | 25 | reactor | 46 |

From this is can be seen that the use of a two-reactor system can be advantageous in multi-step reactions as shown by the increased yields of artemisinin where the acid is present only in the second reactor, and hence only during the second step of the reaction.

### Example 2b

The two stage reaction for the production of artemisinin described in Example 2a was carried out. Instead of using two reactors coupled together in series, as used in Example 2a, the two steps of the reaction were carried out in a single large reactor, comprising two reaction zones, similar to the arrangement illustrated in FIG. 9, which shows three reaction zones.

The photochemical reaction (i.e. step one) was carried out in a first portion of the reactor. The reaction mixture then migrates to a second portion of the reaction chamber, where the second step of the reaction proceeds. This reactor arrangement is particularly useful in reactions where the flow rates in each step of the reaction do not need to be decoupled.

The photosensitiser (TPP, DCA or Ru(bpy)₃Cl₂), TFA and DHAA were dissolved in solvent (toluene or CH₂Cl₂) to the desired concentration of DHAA (0.05 M). The solution was flowed through the reactor at the flow rate stated in Table 4 below and 660 RPM relative rotation speed.

The results of this experiment are set out in Table 4 below. In entry 7, high power LED lights were used.

| | Flow Rate | Solvent | Temp. | | Acid | Artemisinin |
|---|---|---|---|---|---|---|
| Entry | (mL min⁻¹) | (0.05 M) | reactor 1 | Photosensitiser | Addition | Yield (%) |
| 1 | 20 | Toluene | −10 | TPP | Pre-mixed | 45 |
| | | | | (0.5 mol %) | at the | |
| 2 | 15 | Toluene | −10 | TPP | beginning | 51 |
| | | | | (0.5 mol %) | TFA | |
| 3 | 10 | Toluene | −10 | TPP | (0.025 M) | 49 |
| | | | | (0.5 mol %) | | |
| 4 | 20 | Toluene | −10 | DCA | | 9 |
| | | | | (5 mol %) | | |
| 5 | 12 | CH₂Cl₂ | −10 | TPP | | 51 |
| | | | | (0.5 mol %) | | |
| 6 | 20 | CH₂Cl₂ | −10 | Ru(bPY)₃Cl₂ | | 46 |
| | | | | (0.5 mol %) | | |
| 7 | 20 | CH₂Cl₂ | −10 | Ru(bPY)₃Cl₂ | | 23 |
| | | | | (0.5 mol %) | | |

1. An apparatus for carrying out chemical reactions, the apparatus comprising a first reactor/reaction zone for carrying out a first chemical reaction and a second reactor/reaction zone for carrying out a second chemical reaction, wherein each reactor/reaction zone comprises:
a. an inner surface and an outer surface which are spaced apart from each other to define a reaction volume configured such that, in use, a respective chemical reaction takes place in the reaction volume, and wherein the inner surface and outer surface are configured for relative rotation with respect to each other,
b. an inlet for introduction of a reagent to the reaction volume, and
c. an outlet through which a reaction product can leave the reaction volume,
wherein the reaction products of the first reactor/reaction zone comprise reagents of the second reactor/reaction zone.

2. An apparatus according to claim 1, wherein the first and second reactors/reaction zones are provided by first and second reactors respectively, wherein each reaction volume comprises a reaction chamber, and wherein the outlet of the first reactor is coupled to the inlet of the second reactor, optionally via a fluid conduit.

3. An apparatus according to claim 2, wherein first and/or second reactors are configurable such that the speed of relative rotation of the first reactor is the same as or different from the speed of relative rotation of the second reactor; and/or wherein the apparatus is configurable such that a flow rate of fluid from the outlet of the first reactor is equal to the flow rate of fluid into the inlet of the second reactor, for example, the apparatus comprises at least one pump for pumping fluid through the plurality of reactors at a constant flow rate.

4. An apparatus according to claim 1, wherein the first and second reactors/reaction zones are provided by first and second reaction regions of a single reactor, and wherein each reaction volume comprises a portion of a reaction chamber of the single reactor defined by said inner and outer surfaces.

5. An apparatus according to claim 1, wherein the apparatus comprises a third reactor/reaction zone for carrying out a third chemical reaction; optionally wherein the third reactor/reaction zone comprises a third reactor/reaction zone which is provided in series with the first and second reactors; optionally wherein the third reactor/reaction zone comprises a third reactor which is provided in parallel with the first and/or second reactor; optionally wherein the apparatus comprises more than three reactors/reaction zones.

6. An apparatus according to claim 1, wherein one or more of the chemical reactions is a photochemical reaction, an electrochemical reaction and/or a thermal reaction.

7. An apparatus according to claim 1, wherein the inner and/or outer surface of one or more of the reactors/reaction zones is formed of a material which permits electromagnetic radiation of a desired wavelength to be transmitted to the respective reaction chamber; optionally wherein the inner and/or outer surface of at least one reactor/reaction zone permits radiation of a first desired wavelength to be transmitted, and the inner and/or outer surface of at least one other reactor/reaction zone permits radiation of a second desired wavelength to be transmitted, wherein the first and second wavelengths are the same or different; optionally wherein the inner and/or outer surface of at least one reactor/reaction zone permits visible light and/or ultraviolet light and/or infrared radiation to enter the reaction chamber.

8. An apparatus according to claim 1, further comprising an electromagnetic radiation source, e.g. visible light and/or ultraviolet light and/or infrared radiation source.

9. An apparatus according to claim 1, wherein a gap size between the inner surface and the outer surface of one or more of the reactors/reaction zones is up to 6 mm, optionally wherein the gap size is in the range 1-6 mm; optionally wherein one or more of the reactors/reaction zones is configured for carrying out photochemical reactions, and wherein the gap size between the inner surface and the outer surface is about 3 mm.

10. An apparatus according to claim 1, wherein the inner and outer surfaces of at least one reactor/reaction zone are configured as electrodes and wherein the chemical reaction is an electrochemical reaction.

11. A reactor for carrying out chemical reactions, the reactor comprising:
a. an inner surface and an outer surface which are spaced apart from each other to define a reaction chamber, wherein the inner surface and outer surface are configured for relative rotation with respect to each other,
b. an inlet for introduction of a reagent to the reaction chamber, and
c. an outlet through which of a reaction product can leave the reaction chamber,
wherein the inner and outer surfaces are configured as electrodes and wherein the chemical reaction is wholly or partly an electrochemical reaction.

12. A reactor according to claim 11, wherein a gap size between the inner surface and the outer surface of the or at least one reactor/reaction zone is 1.5 mm or less, optionally wherein the gap size is in the range 0.1-1.5 mm, optionally wherein the gap size is about 0.5 mm, optionally wherein the gap size is about 1.0 mm.

13. A reactor according to claim 11, comprising a carbon-containing electrode.

14. A reactor according to claim 11, wherein at least one of the inner or the outer surface comprises a porous material, optionally wherein at least one of the inner or outer surface is coated with a porous material.

15. An apparatus according to claim 1, wherein the inner and outer surfaces of at least one reactor/reaction zone define a reaction chamber/reaction volume having an annular cross section, optionally wherein the inner and outer surfaces comprise approximately concentric cylindrical surfaces.

16. An apparatus according to claim 1, wherein at least one reactor/reaction zone comprises a flow path configured such that fluid can flow along the flow path from the input to the output via the reaction chamber/reaction volume, optionally further comprising a pump configured to generate a continuous flow of fluid along the or each flow path.

17. An apparatus according to claim 1, wherein a gap size between the inner and outer surfaces and/or the speed of relative rotation between the surfaces of at least one reactor/reaction zone is configurable such that, in use, Taylor vortices are generated in fluid present in the reaction chamber/reaction volume.

18. An apparatus according to claim 1, wherein at least one reactor/reaction zone comprises a rotor defining the inner surface of the reaction chamber/reaction volume, wherein the rotor is configured to rotate such that the inner surface rotates with respect to the outer surface of the reaction chamber, optionally wherein the or at least one reactor/reaction zone comprises a reaction vessel defining the outer surface of the reaction chamber/reaction volume, wherein the rotor is located, at least partially, in the reaction vessel.

19. An apparatus according to claim 1, wherein at least one reactor/reaction zone comprises a rotor provided with a rotor jacket covering the rotor, and wherein the rotor jacket defines the inner surface of the reaction chamber/reaction volume, wherein the rotor is configured to rotate such that the inner surface rotates with respect to the outer surface of the reaction chamber/reaction volume, optionally wherein the or at least one reactor/reaction zone comprises a reaction vessel defining the outer surface of the reaction chamber/reaction volume, wherein the rotor is located, at least partially, in the reaction vessel.

20. An apparatus according to claim 1, wherein at least one reactor/reaction zone comprises a reaction vessel defining the outer surface of the reaction chamber/reaction volume or wherein the outer surface is provided by a jacket covering the outer wall of the reaction vessel; optionally wherein the reaction vessel comprises a jacketed vessel through which heating or cooling fluid can be circulated for controlling a temperature of fluid flowing through the reactor.
